(19) United States
(12) Patent Application Publication
(10) Pub. No.: US 2005/0234255 A1
(43) Pub. Date: Oct. 20, 2005

(54) Electrochemical method for the production of organofunctional silanes

(76) Inventors: Thomas Kammel, Ibaraki (JP); Bernd Pachal, Mehring (DE); Christa Grogger, Graz (AT); Bernhard Loidl, Graz (AT); Harald Stuger, Graz (AT)

Correspondence Address: BROOKS KUSHMAN P.C., 1000 TOWN CENTER, TWENTY-SECOND FLOOR, SOUTHFIELD, MI, 48075, US

(21) Appl. No.: 10/515,291

(22) PCT Filed: Apr. 17, 2003
(86) PCT No.: PCT/EP03/04093

§ 371 Date: Jun. 17, 2005

(30) Foreign Application Priority Data
May 29, 2002 (DE) 10223939.8

(51) Int. Cl. C07F 7/04; C07F 7/10; C07F 7/08; C07F 7/18

(52) U.S. Cl. 556/413; 556/436; 556/457; 556/427

(57) ABSTRACT

Organofunctional silanes are prepared in high yield by electrochemically reacting a silane bearing a halo or alkoxy group with a hydrocarbon bearing a halo or alkoxy group in an undivided electrolysis cell with no or minimal complexing agent present.

The invention relates to an electrochemical process for preparing organofunctional silanes using a sacrificial anode.

Shono et al. (Chem. Letters 1985, 463-466) state that it is possible, by electrochemical reduction of benzyl and allyl halides in the presence of trimethylchlorosilane, to prepare the corresponding benzylsilanes (e.g. PhCH₂SiMe₃) and allylsilanes in a divided electrolysis cell with the aid of an inert anode in good yields.

Furthermore, Biran, Bordeau et al. (J. Chim. Phys. 1996, 93, 591-600, Organometallics, 2001, 20(10), 1910-1917), for example, describe the electrochemical preparation of organofunctional silanes using a sacrificial anode and in the presence of complexing agents such as HMPA.

The electrochemical preparation of substituted aromatic halides using the silane dimethyldichlorosilane (silane M2) has likewise been described by Bordeau, Biran et al. (Organometallics, 2001, 20(10), 1910-1917). The advantage of the electrochemical preparation over the classical methods is the high selectivity in the Si—C bond formation. In contrast, the Si—C bond is formed in the classical chemical processes by a coupling reaction with organometallic nucleophiles which have to be generated beforehand with the aid of BuLi or Mg. However, Biran et al. succeeded in the formation of silylated aromatics, for example p-methoxyphenyldimethylchlorosilane, only when the electrolysis is carried out not only in the presence of a complexing agent such as HMPA and a conductive salt (tetrabutylammonium bromide), but also additionally by using a nickel catalyst (nickel bipyridine dichloride) and, as a cocatalyst, 2,2′-bipyridine (see reaction equation below).

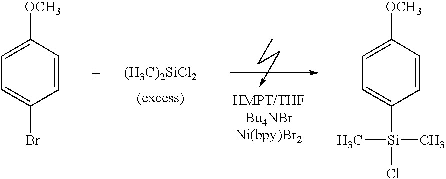

In addition, the silane has to be used in great excess in order to obtain the desired product in acceptable yields. Hitherto, it has only been possible to successfully use bromides as reactants under these conditions.

The invention provides a process for preparing organofunctional silanes of the general formula (I) 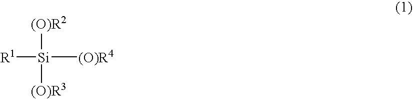
in which a silane of the general formula (2) 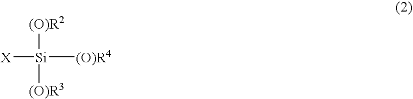
is reacted electrochemically with a compound of the general formula (3)
R¹—Y (3)
using an undivided electrolysis cell, where
R¹ is a radical of the general formula (4)
   R⁶R⁷R⁸C (4)
R⁶, R⁷ and R⁸, individually or together, are monomer, oligomer, or polymer radicals,
R² and R³, individually or together, are optionally substituted C₁-C₃₀-hydrocarbon radicals in which one or more nonadjacent methylene units may be replaced by —O—, —CO—, —COO—, —OCO—, or —OCOO—, —S—, —CO—NR⁵—, —NH— or —N—C₁-C₂₀-hydrocarbon groups, and in which one or more nonadjacent methine units may be replaced by —N═, —N═N— or —P═ groups,
R⁴ is hydrogen or an optionally substituted C₁-C₃₀-hydrocarbon radical in which one or more nonadjacent methylene units may be replaced by —O—, —CO—, —COO—, —OCO—, or —OCOO—, —S—, —CO—NR⁵—, —NH— or —N—C₁-C₂₀-hydrocarbon groups, and in which one or more nonadjacent methine units may be replaced by —N═, —N═N— or —P═ groups,
X and Y are selected from Br, Cl, I, OR⁵ and
R⁵ is a C₁-C₁₀-alkyl radical,
   with the proviso that, per mole of X, at most 0.1 mol of complexing agent is present.

The process works with small amounts and also without the addition of complexing agents such as HMPA (hexamethylphosphoramide) which is dangerous to health or else DMPU (N,N′-dimethylpropyleneurea) and can be carried out without catalyst or cocatalyst. The silanes of the general formula (1) can thus be prepared in a simple and efficient manner.

Furthermore, this process is very widely applicable, i.e. it is possible to use both aromatic and aliphatic halides (and thus not only bromides) which bear widely varying substituents. The reactions proceed stoichiometrically (no need for any excess of silane), the process proceeds very selectively, i.e. by-products are detected only in extremely small amounts, if at all, and the organosilanes of the general formula (1) which are formed can be isolated in good to very good yields (typically 70-90%).

Monomeric R⁶, R⁷ and R⁸ radicals are preferably hydrogen, cyano or optionally substituted C₁-C₃₀-hydrocarbon radicals, in which one or more nonadjacent methylene units may be replaced by —O—, —CO—, —COO—, —OCO—, or —OCOO—, —S—, —CO—NR⁵—, —NH— or —N—C₁-C₂₀-hydrocarbon groups in which one or more nonadjacent methine units may be replaced by —N═, —N═N— or —P=groups, and in which one or more nonadjacent carbon atoms may be replaced by silicon atoms.

Suitable substituents are, for example, halogens, especially fluorine, chlorine, bromine and iodine, cyano, amino.

Particularly preferred monomeric R⁶, R⁷ and R⁸ radicals are C₁-C₂₀-aryl and C₁-C₂₀-alkyl radicals in which nonadjacent methylene units may be replaced by —O— groups and nonadjacent carbon atoms by silicon atoms.

Oligomeric and polymeric R⁶, R⁷ and R⁸ radicals are, for example, polymers, synthetic oligomers and polymers such as polyvinyl chloride, polyethylene, polypropylene, polyvinyl acetate, polycarbonate, polyacrylate, polymethacrylate, polymethyl methacrylate, polystyrene, polyacrylonitrile, polyvinylidene chloride (PVC), polyvinyl fluoride, polyvinylidene fluoride, polyvinylidene cyanide, polybutadiene, polyisoprene, polyethers, polyesters, polyamide, polyimide, silicones, polyvinyl alcohol, polyvinylpyrrolidone, polyacrylamide, polyethylene glycol and derivatives thereof and the like, including copolymers such as styrene-acrylate copolymers, vinyl acetate-acrylate copolymers, ethylene-vinyl acetate copolymers, ethylene-propylene terpolymers (EPDM), ethylene-propylene rubber (EPM), polybutadiene (BR), poly-isobutene-isoprene (butyl rubber, JJR), polyisoprene (IR) and styrene-butadiene rubber (SBR).

Oligomeric and polymeric R⁶, R⁷ and R⁸ radicals are, for example, also natural oligomers and polymers, such as cellulose, starch, casein and natural rubber, and also semisynthetic oligomers and polymers such as cellulose derivatives, for example methylcellulose, hydroxymethylcellulose and carboxymethylcellulose.

The notations of the general formulae (1) and (2) include the possibility that the R², R³ and R⁴ radicals are bonded to the silicon atom directly or via an oxygen atom.

Examples of hydrocarbon radicals R², R³ and R⁴ are alkyl radicals such as the methyl, ethyl, n-propyl, isopropyl, n-butyl, isobutyl, tert-butyl, n-pentyl, isopentyl, neopentyl or tert-pentyl radical, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, octadecyl radicals such as the n-octadecyl radical; alkenyl radicals such as the vinyl and the allyl radical; cycloalkyl radicals such as cyclopentyl, cyclohexyl, cycloheptyl radicals and methylcyclohexyl radicals; aryl radicals such as the phenyl, naphthyl and anthryl and phenanthryl radical; alkaryl radicals such as o-, m-, p-tolyl radicals, xylyl radicals and ethylphenyl radicals; aralkyl radicals such as the benzyl radical, the alpha- and the β-phenylethyl radical. Preferred R², R³ and R⁴ radicals are C₁-C₆-alkyl radicals, in particular methyl and ethyl radicals or phenyl radicals.

It will be appreciated that any mixtures or combinations of compounds of the general formulae (2) and (3) may also be used.

In the process, per mole of X, preferably at most 0.01 mol of, in particular no, complexing agent is present. Complexing agents are, for example, hexamethylphosphoramide (HMPA), N,N′-dimethylpropyleneurea or tetrahydro-1,3-dimethyl-2(1H)-pyrimidinone (DMPH), tris(3,6-dioxaheptyl)amine (TDA-1), tetramethylurea (TMU).

The anode may consist of all materials which have sufficient electrical conductivity and behave chemically inertly under the selected reaction conditions. Preference is given to using a sacrificial anode as the anode. The sacrificial anode comprises a metal or an alloy of metals which dissolve in the process to form cations. Preferred metals are Mg, Fe, Ti, Zn, Al, Cu, Sn, in particular Mg.

The counter electrode (cathode) may likewise consist of all materials which have sufficient electrical conductivity and behave chemically inertly under the selected reaction conditions. Preference is given to graphite or an inert metal such as gold, silver, platinum, rhenium, ruthenium, rhodium, osmium, iridium and palladium, or another metal or an alloy which is quite inert, for example stainless steel.

In order to achieve sufficient conductivity of the reaction mixture at the start of the reaction, preference is given to adding a conductive salt. The conductive salts used are inert salts or mixtures thereof which do not react with the reaction components.

Examples of conductive salts are salts of the general formula M⁺Y⁻, where M is, for example, Mg, Li, Na, NBu₄, NMe₄, NEt₄, and Y is, for example, ClO₄, Cl, Br, I, NO₃, BF₄, ASF₆, BPh₄, PF₆, AlCl₄, CF₃SO₃ and SCN, where Bu, Me, Et and Ph are a butyl, methyl, ethyl and phenyl group respectively. Examples of suitable electrolytes include tetraethylammonium tetrafluoroborate and tetrabutylammonium tetrafluoroborate. Particularly preferred conductive salts are MgCl₂ and LiCl.

The process preferably takes place in a solvent. Useful solvents are all aprotic solvents which do not react with the compounds of the general formulae (1) to (3) and are themselves only reduced at a more negative potential than the compounds of the general formula (2). Suitable solvents are any in which the compounds used are at least partly soluble under operatingconditions with regard to concentration and temperature. In a specific embodiment, the compounds of the general formulae (2) and (3) used may themselves serve as solvents. An example thereof is dimethyldichlorosilane.

Examples of suitable solvents are ethers such as tetrahydrofuran, 1,2-dimethoxyethane, 1,3-dioxolane, bis(2-methoxyethyl)ether, dioxane, acetonitrile, γ-butyrolactone, nitromethane, liquid SO₂, tris(dioxa-3,6-heptyl)amine, trimethylurea, dimethylformamide, dimethyl sulfoxide, and mixtures of these solvents.

The solvents are preferably dry. Particular preference is given to tetrahydrofuran.

The concentration of compound of the general formula (3) in the solvent is preferably from 0.05 to 5 mol/l, in particular from 0.1 to 2 mol/l.

Based on 1 mol of compound of the general formula (3), the amount of compound of the general formula (2) used is preferably from 0.8 to 1.5 mol, in particular from 0.9 to 1.2 mol.

The process may be carried out by any customary route using an electrolysis cell having a cathode and a sacrificial anode. The electrolysis cell may be a divided or undivided electrolysis cell, but preference is given to the undivided electrolysis cell, since it has the simplest construction. The process preferably takes place under an inert gas atmosphere, and preferred inert gases are nitrogen, argon or helium.

The electrolysis cell is preferably equipped with a potentiostat or a galvanostat (constant current flow), in order to control the potential or the intensity of the current. The reaction may be carried out with and without controlled potential.

Based on the compound of the general formula (3), the amount of charge Q is preferably from 1.1 to 5 F/mol, in particular from 1.5 to 3 mol/F.

The process preferably takes place under the influence of ultrasound.

The temperature in the process is preferably from 5° C. to 50° C., in particular from 10 to 30° C.

All of the above symbols of the above formulae are each defined independently of one another. In all formulae, the silicon atom is tetravalent.

Unless stated otherwise, all amount and percentage data in the examples which follow are based on the weight, all pressures are 0.10 MPa (abs.) and all temperatures are 20° C.

The reactions are carried out under a protective gas atmosphere (argon, nitrogen), all solvents used are dry and the reactants used are each highly pure.

Electrolysis Setup:

For the electrolysis, an undivided electrolysis cell is used in which the rod-shaped sacrificial anode (diameter 8 mm) made of highly pure magnesium is disposed in the center and the cathode which consists of a cylindrical stainless steel sheet of diameter 4 cm is disposed around the anode. The electrolysis is carried out galvanostatically, and the current density at the cathode does not exceed 0.5 mA/cm². The electrolysis cell is sonicated over the entireelectrolysis time in an ultrasound bath which is cooled by water so that the temperature does not rise significantly above RT (20° C.).

### EXAMPLE 1

### Preparation of (p-methoxyphenyl)dimethylsilane

1.2 g (28.3 mmol) of anhydrous lithium chloride are dissolved in 50 ml of dry THF and transferred to a dry electrolysis cell flushed with protective gas. After 5.00 g (35.1 mmol) of p-chloroanisole and 3.32 g (35.1 mmol) of chlorodimethylsilane have been added, electrolysis is effected at a constant current of 15 mA (current density i=0.4 mA/cm²). After a total reaction time of 138 h (N.B.: this corresponds to an amount of charge Q of 2.2 F/mol), the electrolysis is terminated. Workup: after the THF solvent has been removed under reduced pressure, the remaining residue is admixed with 75 ml of a saturated, aqueous ammonium chloride solution and subsequently extracted a total of 3× with 50 ml each time of n-pentane. The organic phases are combined and dried over sodium sulfate. After the n-pentane solvent has been removed, 4.95 g of the desired product, (pmethoxyphenyl)dimethylsilane, are obtained (yield: 85% of theory).

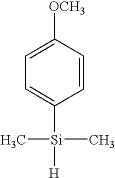

### EXAMPLE 2

### Preparation of (p-methoxyphenyl)dimethylsilane

In a similar manner to example 1, 10.00 g (53.5 mmol) of 4-bromoanisole are reacted electrochemically with the stoichiometric amount of 5.06 g (53.5 mol) of chlorodimethylsilane. After an electrolysis time of 48 h and similar workup to example 1, the desired product, p-methoxyphenyldimethylsilane, is obtained in an 85% yield.

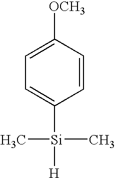

### EXAMPLE 3

### Synthesis of [4-(N,N-dimethylamino)phenyl]-dimethylsilane

In a similar manner to example 1, starting from 5.00 g (25.0 mmol) of 4-bromo-N,N-dimethylaniline, electrochemical reaction is effected with 2.36 g (25 mmol) of chlorodimethylsilane. After an electrolysis time of 98 h (amount of charge Q=2.2 F/mol) and similar workup to example 1, 3.12 g of [4-(N,N-dimethylamino)phenyl]-dimethylsilane are obtained; this corresponds to a yield of 70% (of theory).

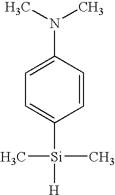

### EXAMPLE 4

### Preparation of [4-(dimethylsilyl)phenoxy]-tert-butyldimethylsilane

In analogy to example 1, 7.50 g (26.1 mmol) of (4-bromophenoxy)-tert-butyldimethylsilane are reacted electrochemically with 2.47 g (26.1 mmol) of chlorodimethylsilane. After a total electrolysis time of 103 h (amount of charge Q=2.2 F/mol) and similar workup to example 1, 6.40 g of [4-(dimethylsilyl)phenoxy]-tert-butyldimethylsilane are obtained. This corresponds to a yield of 90% of theory.

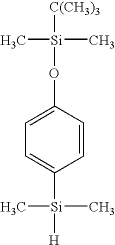

### EXAMPLE 5

### Preparation of n-pentyldimethylsilane

In a similar manner to example 1, starting from 4.00 g (37.5 mmol) of 1-chloropentane and 3.55 g (37.5 mmol) of chlorodimethyl-silane, after an electrolysis time of 147 h (amount of charge Q=2.2 F/mol) and similar workup to example 1, a total of 4.15 g of the desired product, n-pentyldimethylsilane, are obtained. This corresponds to a yield of 85%.

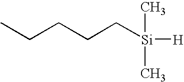

### EXAMPLE 6

### Preparation of n-hexyldimethylsilane

In analogy to example 1, starting from 5.00 g (30.3 mmol) of hexyl bromide and the stoichiometric amount of 2.86 g (30.3 mmol) of chlorodimethyl-silane, after an electrolysis time of 22 h and similar workup to example 1, a total of 2.90 g of the product, n-hexyldimethylsilane, are obtained. This corresponds to a yield of 66% of theory.

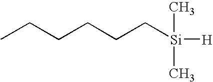

### EXAMPLE 7

### Synthesis of (p-methoxyphenyl)methoxydimethylsilane

5.00 g (35.1 mmol) of p-chloranisole and 4.22 g (35.1 mmol) of dimethoxydimethylsilane are reacted with one another electrochemically in a similar manner to example 1. After a total electrolysis time of 138 h (amount of charge Q=2.2 F/mol) and similar workup to example 1, 5.50 g of the product, p-methoxyphenylmethoxydimethylsilane, are obtained (yield: 80% of theory).

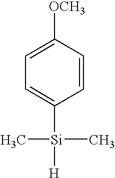

### EXAMPLE 8

### Synthesis of (p-methoxyphenyl)methoxydimethylsilane

Starting from 5.00 g (26.7 mmol) of p-bromoanisole and the stoichiometric amount of 3.20 g (26.7 mmol) of dimethoxydimethylsilane, 2.72 g of the desired product (52% of theory) are in a similar manner to example 1 after an electrolysis time of 24 h and the same workup as in example 1.

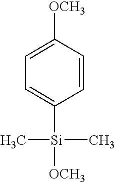

### EXAMPLE 9

### Preparation of [4-(methoxydimethylsilyl]-phenoxy]-tert-butyldimethylsilane

In a similar manner to example 1, 7.50 g (26.1 mmol) of (4-bromophenoxy)-tert-butyldimethylsilane are electrolyzed with a stoichiometric amount of dimethoxydimethylsilane (3.14 g (26.1 mmol)). After a total electrolysis time of 103 hours (Q=2.2 F/mol) and similar workup to example 1, 4.60 g of the desired product, [4-(methoxydimethylsilyl)phenoxy]-tert-butyldimethylsilane, are obtained. This corresponds to a yield of 60% of theory.

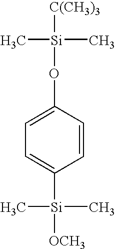

### EXAMPLE 10

### Synthesis of (N,N-diethylamino)-p-methoxyphenyldimethylsilane

In analogy to example 1, 2.80 g (15.1 mmol) of p-bromoanisole and the stoichiometric amount of 2.50 g (15.1 mmol) of (N,N-diethylamino)dimethylchlorosilane are reacted electrochemically. After 24 h, the electrolysis is ended. After workup in a similar manner to example 1, 1.62 g of the desired product, (N,N-diethylamino)-p-methoxyphenyldimethylsilane, (45% of theory) are obtained.

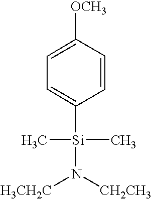

### EXAMPLE 11

### Synthesis of (3-butenyl)methoxydimethylsilane

4.00 g (29.6 mmol) of 4-bromo-1-butene are reacted electrochemically with 3.56 g (29.6 mmol) of dimethoxydimethylsilane in a similar manner to example 1. After an electrolysis time of 116 h (amount of charge Q=2.2 F/mol) and similar workup to example 1, 3.50 g of the desired product, (3-butenyl)methoxydimethylsilane, are obtained. This corresponds to a yield of 83%.

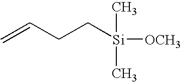

### EXAMPLE 12

### Preparation of poly[(dimethylsilyl)ethylene-co-vinyl chloride

In analogy to example 1, starting from 1.00 g (16 mmol of Cl) of polyvinyl chloride and 1.51 g (16 mmol) of chlorodimethylsilane, electrolysis is effected at a constant current of 15 mA. After a total reaction time of 63 h (amount of charge Q=2.2 F/mol), the electrolysis is ended. The reaction solution is concentrated to half its volume by partly removing the solvent under reduced pressure. The concentrated solution is subsequently added dropwise to 250 ml of methanol slowly and with vigorous stirring, in the course of which the polymer formed precipitates out. The precipitated polymer is washed a total of three times with in each case 150 ml of methanol and finally dried under reduced-pressure to constant weight.

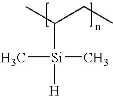

### EXAMPLE 13

### Synthesis of n-pentyldimethylsilane

In a similar manner to example 5 but using a titanium anode instead of a magnesium anode, 4.00 g (37.5 mmol) of 1-chloropentane and 3.55 g (37.5 mmol) of chlorodimethylsilane are electrolyzed under the same conditions for a total of 8 d. GC-MS analysis detects in the crude product, in addition to the reactant, the desired product (composition: 55% of the n-pentyldimethylsilane target product, 45% of the 1-chloropentane reactant).

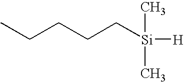

### COMPARATIVE EXAMPLE

### Synthesis of p-methoxyphenyldimethylchlorosilane (from Biran, Bordeau et al. Organometallics 2001, 20(10), 1910-1917)

In an undivided electrolysis cell (100 ml) which is equipped with a cylindrical aluminum or magnesium rod (diameter 1 cm) as the sacrificial anode and a concentric stainless steel grid (or carbon) as the cathode (surface area: 1.0±0.2 dm²), the reaction is carried out under a nitrogen atmosphere as follows:

A constant current of 0.1 A (current density: 0.1±0.05 A dm⁻²) is applied and the dried cell is charged successively with dry THF (20 ml), HMPA (6 ml) and the silane (40-60 ml). After the degassing of the reaction solution and pre-electrolysis (removal of residual traces of water with formation of the corresponding, electrochemically inert siloxane), 0.45 g (1.2 mmol) of the NiBr₂ (bpy) nickel catalyst and an excess of the 2,2′-bipyridine cocatalyst (0.78 g, 5 mmol) are added. The electrolysis (i=0.1 A) is carried out until the theoretical amount of charge has been attained. After similar workup to the above examples, the desired product, p-methoxyphenyldimethylchlorosilane, is obtained. The yield is 86%. In the absence of the catalyst and of the cocatalyst, the conversion rates are between 8-13%, with the catalysts at 98%.

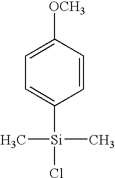

1-8. (canceled)

9. A process for preparing organofunctional silanes of the formula (I) 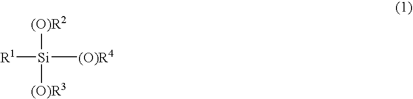
in which a silane of the formula (2) 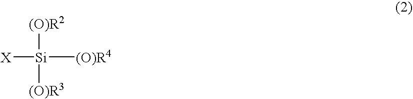
is reacted electrochemically with a compound of the formula (3)
R¹—Y (3)
in an undivided electrolysis cell having at least one anode and at least one cathode, where
R¹ is a radical of the general formula (4)
R⁶R⁷R⁸C (4)
R⁶, R⁷ and R⁸, individually or together, are monomer, oligomer, or polymer radicals,
R² and R³, individually or together, are optionally substituted C₁-C₃₀ hydrocarbon radicals in which one or more nonadjacent methylene units are optionally replaced by —O—, —CO—, —COO—, —OCO—, or —OCOO—, —S—, —CO—NR⁵—, —NH— or —N—C₁-C₂₀-hydrocarbon groups, and in which one or more nonadjacent methine units are optionally replaced by —N═, —N═N— or —P=groups,
R⁴ is hydrogen or an optionally substituted C₁-C₃₀ hydrocarbon radical in which one or more nonadjacent methylene units are optionally replaced by —O—, —CO—, —COO—, —OCO—, or —OCOO—, —S—, —CO—NR⁵—, —NH— or —N—C₁-C₂₀-hydrocarbon groups, and in which one or more nonadjacent methine units are optionally replaced by —N═, —N═N— or —P═ groups,
X and Y are individually selected from the group consisting of Br, Cl, I, and OR⁵, and
R⁵ is a C₁-C₁₀ alkyl radical,
with the proviso that, per mole of X, at most 0.1 mol of complexing agent is present.

10. The process of claim 9, wherein R⁶, R⁷ and R⁸ are monomer radicals individually selected from the group consisting of hydrogen, cyano, and optionally substituted C₁-C₃₀-hydrocarbon radicals in which one or more nonadjacent methylene units may be replaced by —O—, —CO—, —COO—, —OCO—, or —OCOO—, —S—, —CO—NR⁵—, —NH— or —N—C₁-C₂₀-hydrocarbon groups and in which one or more nonadjacent methine units replaced by —N═, —N═N— or —P═ groups, and in which one or more nonadjacent carbon atom(s) are optionally replaced by silicon atoms.

11. The process of claim 9, wherein R⁶, R⁷ and R⁸ are oligomer or polymer radicals individually selected from the group consisting of polyvinyl chloride, polyethylene, polypropylene, polyvinyl acetate, polycarbonate, polyacrylate, polymethacrylate, polymethyl methacrylate, polystyrene, polyacrylonitrile, polyvinylidene chloride, polyvinyl fluoride, polyvinylidene fluoride, polyvinylidene cyanide, polybutadiene, polyisoprene, polyethers, polyesters, polyamide, polyimide, silicones, polyvinyl alcohol, polyvinylpyrrolidone, polyacrylamide, polyethylene glycol and their derivatives and copolymers.

12. The process of claim 9, wherein R⁶, R⁷, and R⁸ are oligomer or polymer radicals comprising co- or terpolymers individually selected from the group consisting of styrene-acrylate copolymers, vinyl acetate-acrylate copolymers, ethylene-vinyl acetate copolymers, ethylene-propylene terpolymers, ethylene-propylene rubber, polybutadiene, poly-isobutene-isoprene, polyisoprene, and styrene-butadiene rubber.

13. The process of claim 9, wherein the anode is a sacrificial anode and comprises a metal or an alloy of at least one metal selected from the group consisting of Mg, Fe, Ti, Zn, Al, Cu and Sn.

14. The process of claim 9, wherein at least one conductive salt of the formula M⁺Y⁻ is added where M is Mg, Li, Na, NBu₄, NMe₄, or NEt₄, and Y is ClO₄, Cl, Br, I, NO₃, BF₄, AsF₆, BPh₄, PF₆, AlCl₄, CF₃SO₃ or SCN.

15. The process of claim 9, wherein an aprotic solvent is present which does not react with the compounds of the formulae (1) to (3) and which itself is reduced only at a more negative potential than the compounds of the formula (2).

16. The process of claim 1, wherein based on 1 mol of compound of the formula (3), the amount of compound of the formula (2) used is from 0.8 to 1.5 mol.

17. The process of claim 9, which is carried out in the presence of ultrasonic energy.

18. The process of claim 9, wherein said complexing agent is present in an amount of less then 0.01 mol per mol of X.

19. The process of claim 9, wherein no complexing agent is present.

20. The process of claim 15, wherein said aprotic solvent comprises tetrahydrofuran.

21. The process of claim 9 wherein at least one compound of the formula 2 is selected from the group consisting of silanes of the formula
XSiR₃
where X is C1 or OR⁵ where R⁵ is C₁₋₁₀ alkyl, and each R independently is H, C₁₋₆ alkyl, or phenyl.

22. The process of claim 9, wherein at least one compound of the formula 2 is selected from the group consisting of chlorodimethyl-silane dimethoxydimethylsilane, (N,N-dimethylamino)dimethylchlorosilane and (3-butenyl)methoxydimethylchlorosilane.

23. The process of claim 9, wherein said compound of the general formula 2 is a silane bearing a silicon-bonded hydrogen.

24. The process of claim 9, wherein said compound of formula 2 is a chlorosilane or methoxysilane bearing an ethylenically unsaturated hydrocarbon group.
